(19) United States
(12) Patent Application Publication
(10) Pub. No.: US 2005/0135395 A1
(43) Pub. Date: Jun. 23, 2005

(54) Method and system for pre-pending layer 2 (L2) frame descriptors

(76) Inventors: Kan F. Fan, Diamond Bar, CA (US); Scott McDaniel, Villa Park, CA (US)

Correspondence Address: MCANDREWS HELD & MALLOY, LTD, 500 WEST MADISON STREET, SUITE 3400, CHICAGO, IL, 60661, US

(21) Appl. No.: 11/009,258

(22) Filed: Dec. 9, 2004

Related U.S. Application Data
(60) Provisional application No. 60/532,211, filed on Dec. 22, 2003.

(51) Int. Cl. H04L 12/56; H04L 12/28

(52) U.S. Cl. 370/412

(57) ABSTRACT

Method and system for arranging and processing packetized network information are provided herein. A single receive buffer may be allocated in a host memory for storing packet data and control data associated with a packet and a single DMA operation may be generated for transferring the packet data and the control data into the single allocated receive buffer. A plurality of the single receive buffers may be arranged so that they are located contiguously in the host memory. The packet data and the control data for the packet may be written in the single receive buffer via the single DMA operation. At least one pad byte may be inserted in the single receive buffer for byte alignment. The pad may separate the control data from the packet data in the single receive buffer. The control data may comprise packet length data, status data, and/or checksum data.

### CROSS-REFERENCE TO RELATED APPLICATIONS/INCORPORATION BY REFERENCE

This application makes reference to, claims priority to, and claims the benefit of U.S. Provisional Application Ser. No. 60/532,211 (Attorney Docket No. 15414US01), filed Dec. 22, 2003 and entitled “Method And System For Prepending Layer 2 (L2) Frame Descriptors.”

The above stated application is incorporated herein by reference in its entirety.

### FIELD OF THE INVENTION

Certain embodiments of the invention relate to network interface processing of packetized information. More specifically, certain embodiments of the invention relate to a method and system for pre-pending layer 2 (L2) frame descriptors.

### BACKGROUND OF THE INVENTION

The International Standards Organization (ISO) has established the Open Systems Interconnection (OSI) reference model. The OSI reference model provides a network design framework allowing equipment from different vendors to be able to communicate. More specifically, the OSI reference model organizes the communication process into seven separate and distinct, interrelated categories in a layered sequence. Layer 1 is the Physical Layer, which handles the physical means of sending data. Layer 2 is the Data Link Layer, which is associated with procedures and protocols for operating the communications lines, including the detection and correction of message errors. Layer 3 is the Network Layer, which determines how data is transferred between computers. Layer 4 is the Transport Layer, which defines the rules for information exchange and manages end-to-end delivery of information within and between networks, including error recovery and flow control. Layer 5 is the Session Layer, which deals with dialog management and controlling the use of the basic communications facility provided by Layer 4. Layer 6 is the Presentation Layer, and is associated with data formatting, code conversion and compression and decompression. Layer 7 is the Applications Layer, and addresses functions associated with particular applications services, such as file transfer, remote file access and virtual terminals.

In some conventional layer 2 (L2) network interface cards (NICs), a host driver provides a buffer descriptor (BD) queue (BDQ) which may point to the buffers for receiving packets. When the network interface card (NIC) receives a packet, it allocates a buffer from a receive BDQ and writes the packet data to the allocated buffer. In addition, control information which may comprise packet length, packet status, computed checksums an other data, are also written to another data structure which may be referred to as a receive return BDQ. The receive return queue may be allocated or mapped to an address within the host memory, which is different from the BDQ. Accordingly, the network interface card essentially has to perform two direct memory access DMA writes to the two different memory locations for each packet. Performing DMA writes to two separate memory locations for each packet may decrease the processing efficiency of the network interface card. This may be particularly true in instances where the data packets being handled are short, but at the maximum data rate. In this case, since the data packets are short and the receive return queue DMA is short, the overhead associated with each DMA begins to take a large percentage of the possible DMA bandwidth compared to the data and status payload. The launching of two separate DMA writes per packet also increases system latency.

FIG. 1 is a block diagram of an exemplary conventional system 100 for L2 processing, illustrating two separate DMA writes for each packet. Referring to FIG. 1, the system 100 may comprise a host memory 101 and a NIC 103. The host memory 101 may comprise a receive BDQ 107, a receive return BDQ 109 and a plurality of buffers 111. The NIC 103 is connected to the host memory 101 via an interface bus 105. In addition, the NIC 103 may receive data via the incoming data flow 119.

In operation, the NIC may receive packet data 115 via the incoming data flow 119 and may perform two direct memory access (DMA) writes to two different memory locations for the packet data 115. For example, the NIC 103 may allocate a buffer B1 from the receive BDQ 107 and may write the received packet data 115 into the allocated buffer B1 from the plurality of buffers 111. In addition, control information 117 may be associated with the received packet data 115. The control information 117 may comprise, for example, packet length, packet status, computed checksums and/or other control data associated with the received packet data 115. The control information 117 may then be written into the receive return BDQ 109, which may be allocated or mapped to a different address within the host memory 101.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for pre-pending layer 2 (L2) frame descriptors. An embodiment of the invention may provide a method for merging separate DMA write accesses to a buffer descriptor (BD) queue (BDQ) and a receive return queue (RRQ) for each packet into a single DMA write operation over a contiguous buffer. By merging and reducing the two separate DMA writes into a single DMA write, DMA latency is improved by the reduction of overhead incurred by the launching of two separate DMA operations. Additionally, by utilizing contiguous buffers, a networking system chipset or bridge may more efficiently utilize network and processing bandwidths.

Another embodiment of the invention may provide a method for arranging and processing packetized network information. A single receive buffer may be allocated in a host memory for storing packet data and control data associated with a packet and a single DMA operation may be generated for transferring the packet data and the control data into the single allocated receive buffer. A plurality of the single receive buffers may be arranged so that they are located contiguously in the host memory. The packet data and the control data for the packet may be written in the single receive buffer via the single DMA operation. At least one pad byte may be inserted in the single receive buffer for byte alignment. The at least one pad may separate the control data from the packet data in the single receive buffer. The control data may comprise packet length data, status data, and/or checksum data. At least one buffer descriptor may be allocated for storing identifying information associated with the single receive buffer. The identifying information may comprise host memory address and/or buffer size information. A consumer index may be allocated in the host memory, where the consumer index may be utilized for updating notification information associated with the packet. The notification information may be communicated to a host driver, where the host driver may be interfaced to the host memory. The host driver may determine, upon receipt of the notification information, whether the packet is acceptable for a read operation.

Another embodiment of the invention may provide a machine-readable storage, having stored thereon, a computer program having at least one code section executable by a machine, thereby causing the machine to perform the steps as described above for arranging and processing packetized network information.

Certain aspects of the system for arranging and processing packetized network information may comprise a host memory, a single receive buffer allocated in the host memory for storing packet data and control data associated with a packet, and a single DMA operation that transfers the packet data and the control data into the single allocated receive buffer. A plurality of the single receive buffers may be arranged so that they are located contiguously in the host memory. The packet data and the control data for the packet may be written in the allocated single receive buffer via the single DMA operation. The single receive buffer may comprise at least one pad byte, where the pad byte may separate the control data from the packet data in the single receive buffer. The control data may comprise packet length data, status data, and/or checksum data. At least one buffer descriptor may be allocated for storing identifying information associated with the single receive buffer. The identifying information may comprise host memory address and/or buffer size information. A consumer index may be allocated in the host memory, where the consumer index may be utilized for updating notification information associated with the packet. At least one notification may be communicated to a host driver, where the host driver may be interfaced to the host memory. The host driver may determine, upon receipt of the notification information, whether the packet is acceptable for a read operation.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary conventional system for L2 processing, illustrating two separate DMA writes for each packet.

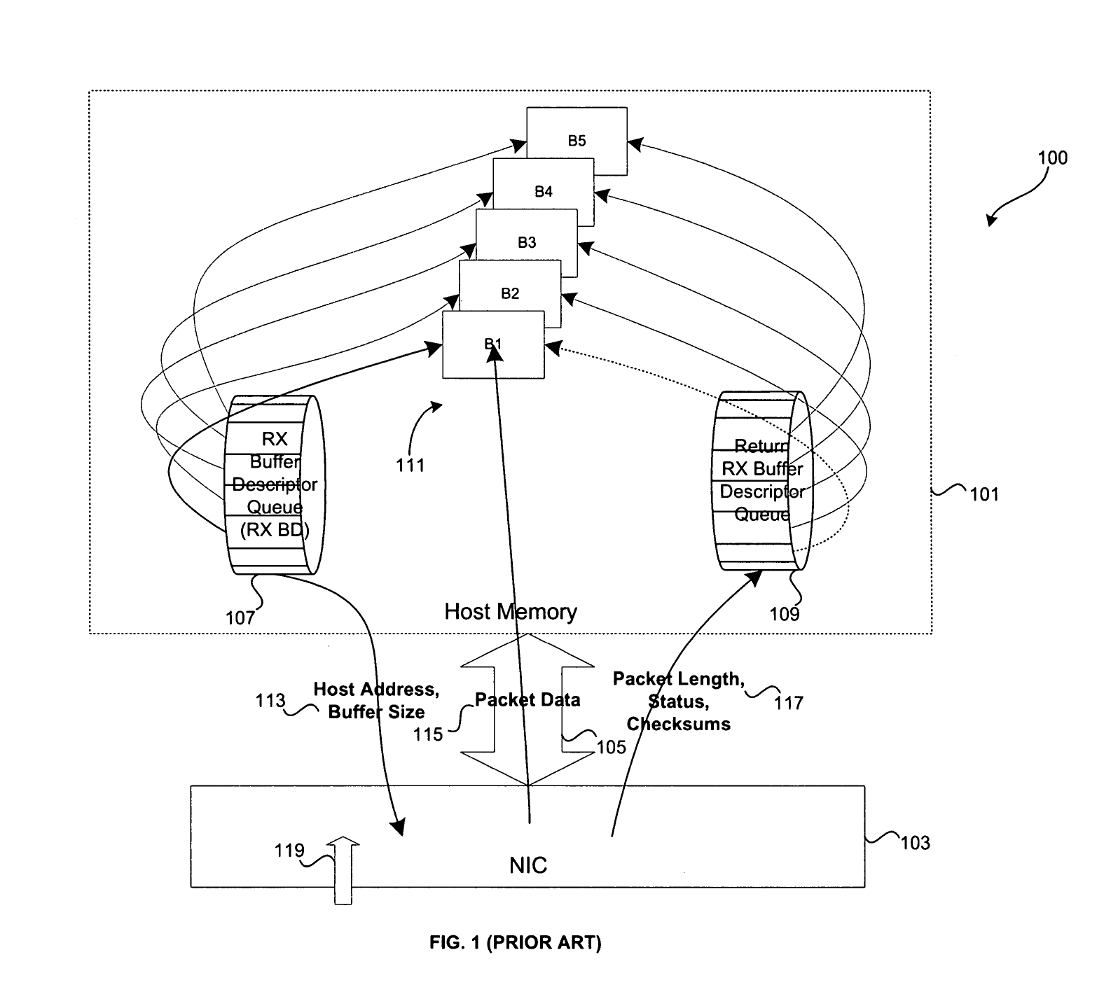

FIG. 2 is a block diagram of an exemplary implementation of a receive buffer which is adapted to facilitate the pre-pending of layer 2 (L2) frame descriptor, in accordance with an embodiment of the present invention.

FIG. 3 is a block diagram illustrating pre-pending of layer 2 (L2) frame descriptors, in accordance with an embodiment of the present invention.

FIG. 4 is a block diagram of an exemplary system that may be used in connection with pre-pending layer 2 (L2) frame descriptors, in accordance with an embodiment of the present invention.

FIG. 5 is a flow diagram illustrating a method for processing packetized network information that may be used in connection with pre-pending layer 2 (L2) frame descriptors, in accordance with an embodiment of the present invention.

### DETAILED DESCRIPTION OF THE INVENTION

Aspects of the invention may be found in a method for merging separate DMA write accesses to a buffer descriptor (BD) queue (BDQ) and a receive return queue (RRQ) for each packet into a single DMA write over a contiguous buffer. By merging and reducing the two separate DMA writes into a single DMA write, DMA latency is improved by the reduction of overhead incurred by the launching of two separate DMA operations. Additionally, by utilizing contiguous buffers, a networking system chipset or bridge may more efficiently utilize bandwidth.

According to a different embodiment of the present invention, a method for arranging and processing packetized network information may include allocating a single receive buffer in a host memory for storing packet data and control data associated with a packet. The packet data and the control data may be transferred and written into the single allocated receive buffer via a single DMA operation. The control data may comprise packet length data, status data, and/or checksum data. A pad byte may be inserted in the single receive buffer for byte alignment, where the pad may separate the control data from the packet data in the single receive buffer. A plurality of the single receive buffers may be arranged so that they are located contiguously in the host memory. A buffer descriptor may be allocated for storing identifying information, such as host memory address and/or buffer size information, associated with the single receive buffer. A consumer index may be allocated in the host memory, where the consumer index may be utilized for updating notification information associated with the packet data. The notification information may be communicated to a host driver and/or a host memory interfaced with the host driver. Upon receipt of the notification information, the host driver may determine whether the packet is acceptable for a read operation, for example.

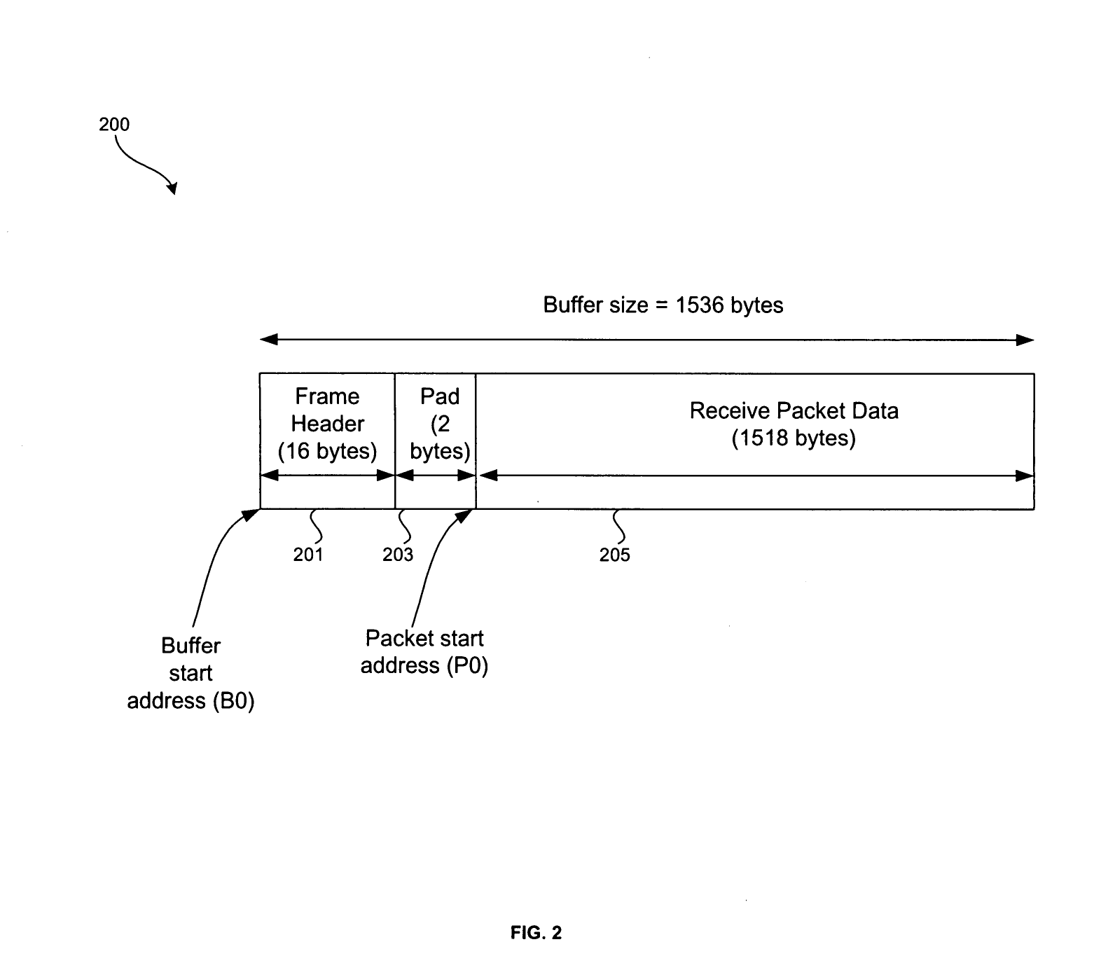

FIG. 2 is a block diagram of an exemplary implementation of a receive buffer which is adapted to facilitate the pre-pending of layer 2 (L2) frame header, in accordance with an embodiment of the present invention. Referring to FIG. 2, there is illustrated an exemplary receive buffer 200. The receive buffer 200 may be adapted to store a frame header 201, a pad 203 and receive packet data 205. The receive buffer 200 may be 1536 bytes long. The frame header 201 may start at the buffer start address B0 and may occupy the first 16 bytes of the receive buffer 200. The frame header 201 may be utilized for storing control data, such as, for example, packet length, status and checksums.

The pad 203 may be adjacent to the frame header 201 and it may comprise two bytes. The remaining 1518 bytes of the receive buffer 200 may be utilized for the receive packet data 205, beginning at a packet start address P0. The packet start address P0 may be calculated by a host system driver as the sum of the buffer start address, size of frame header and padding. The pad bytes 203 may be utilized for header alignment, for example. In accordance with an aspect of the invention, the frame header, pad and packet data may be stored contiguously in a host memory.

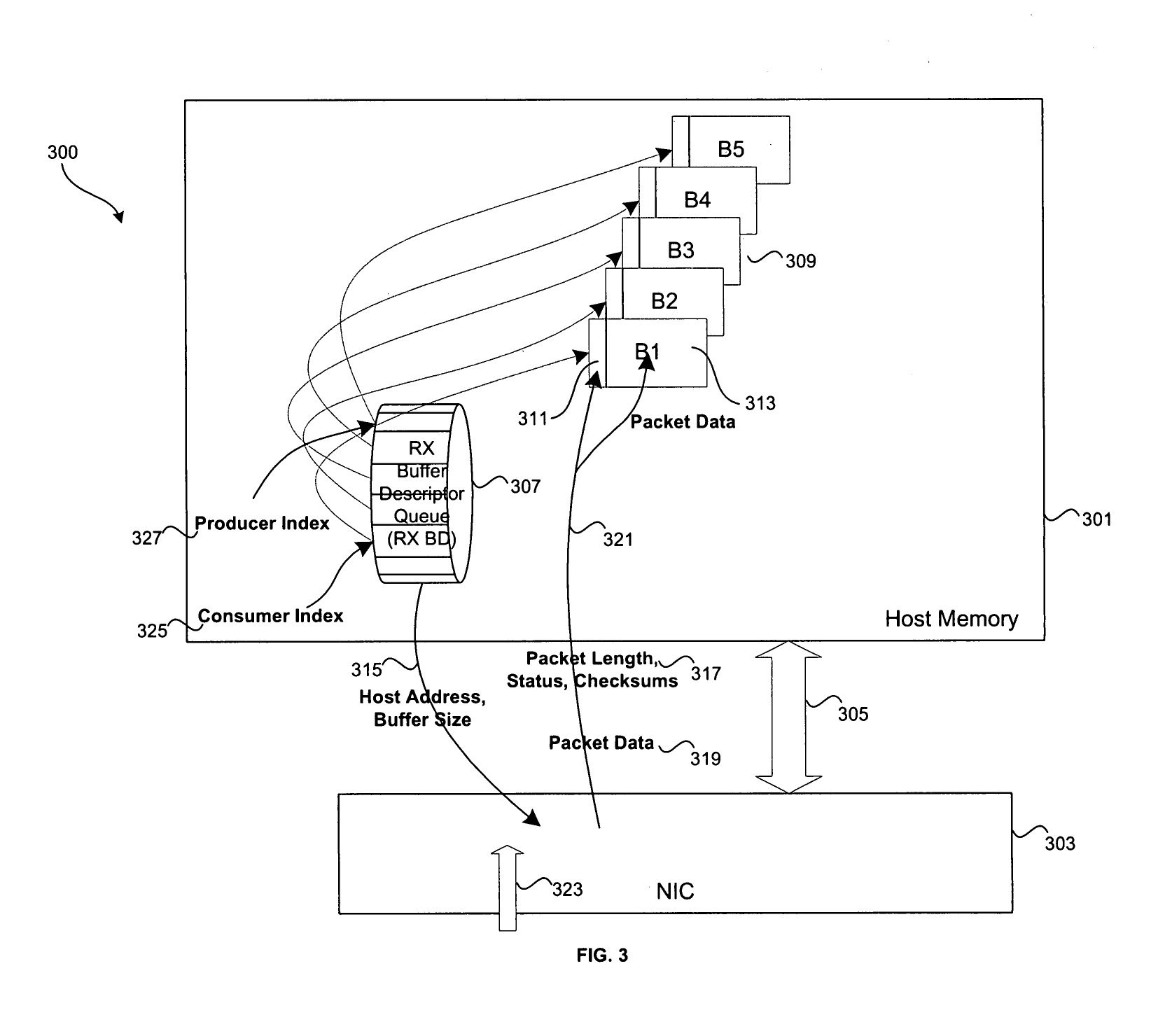

FIG. 3 is a block diagram illustrating pre-pending of a layer 2 (L2) frame header in accordance with an embodiment of the invention. Referring to FIG. 3, there is shown a host memory 301 coupled to a NIC 303 via an interface bus 305. On the host memory 301, there is shown a receive BDQ 307 and a plurality of receive buffers 309. Each of the plurality of receive buffers 309 may comprise a frame header portion and a receive packet data portion. For example, the receive buffer B1 may comprise a frame header portion 311 and a receive packet portion 313. The frame header portion 311 and the receive packet portion 313 may be separated by a pad for byte alignment. On the NIC 303 there is shown a receive data flow 323 for receiving packet data.

In operation, prior to or before a packet is received via the receive data flow 323, the NIC 303 may fetch a receive buffer descriptor 315 from the receive BDQ 307. The receive buffer descriptor 315 may comprise a host buffer address and a buffer size. For example, the buffer descriptor 315 may comprise buffer address and buffer size information associated with the buffer B1. The NIC 303 may then allocate a buffer B1 from the plurality of receive buffers 309. Starting from the buffer address in the frame header portion 311 of buffer B1, the NIC 303 may launch a single DMA write operation 321 of the frame header control information 317 of the received packet, padding and packet data 319, which may be contiguously stored in the host memory 301. The frame header control information 317 may comprise, for example, packet length, packet status, computed checksums and/or other control data associated with the received packet data.

In an embodiment of the present invention, the NIC 303 may update a consumer index 325 and/or a producer index 327 of the receive BDQ 307 to notify a host driver of the arrival of a new packet. The host driver may then read the frame header control information 311 in order to determine if the packet is acceptable for a read operation, for example. If the packet is accepted, the host driver may pass an address of the packet B1, skipping the frame header and padding, upward to a protocol stack. Since the frame header control information, 317, pad and packet data 319 are stored contiguously in the host memory 301, only one DMA write operation 321 is launched for each received packet instead of the two DMA operations that are utilized in conventional network interface packet processing systems. In accordance with an aspect of the invention, the NIC 303 may only need to know a single host address for writing control information and packet data. For example, the buffer address for buffer B1 is the only buffer address that may be required for a single packet transfer. Furthermore, since the frame header control information 317 and pad and packet data 319 are stored contiguously in the host memory 301 and only a single DMA write operation 321 is utilized, then a system chipset or bridge residing between a NIC and a host memory may more efficiently utilize the host memory bandwidth.

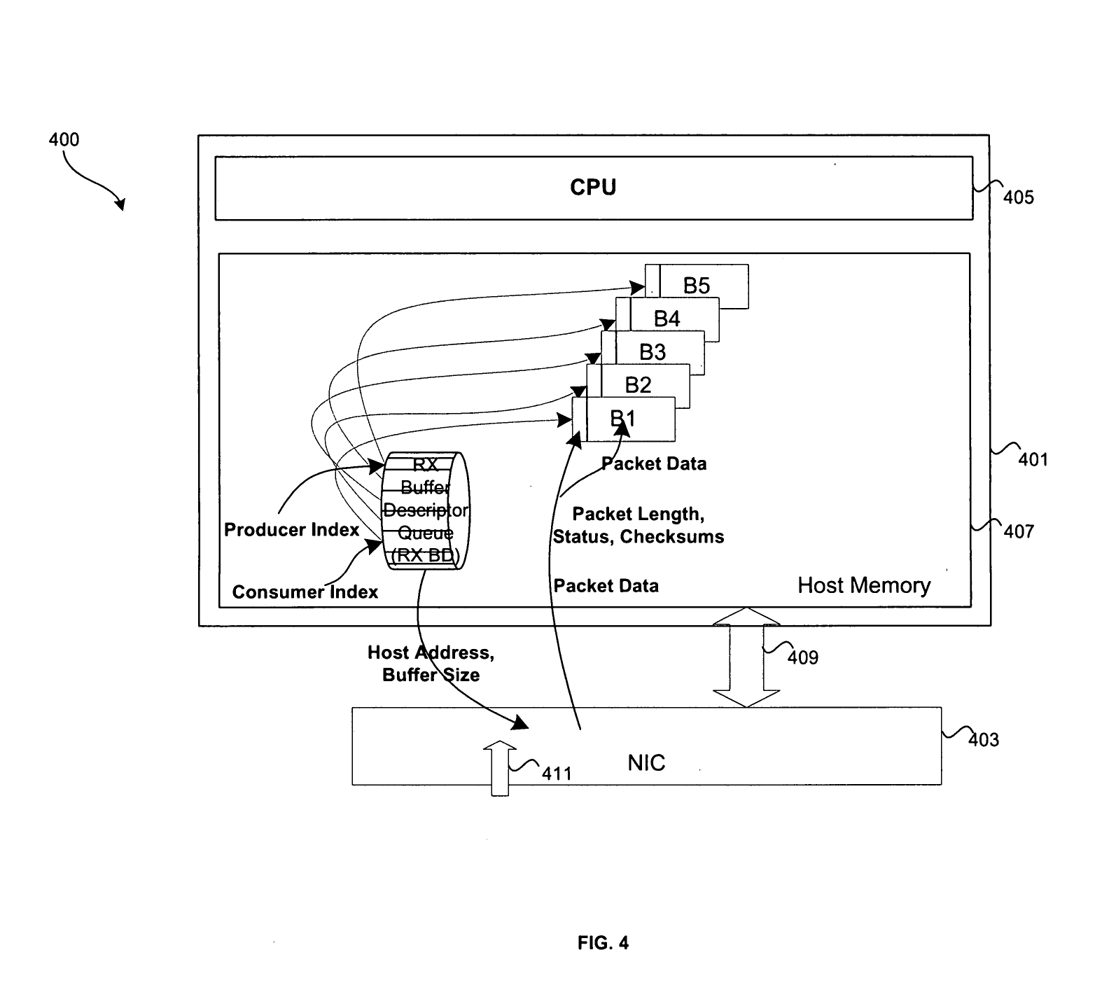

FIG. 4 is a block diagram of an exemplary system that may be used in connection with pre-pending layer 2 (L2) frame descriptors, in accordance with an embodiment of the present invention. Referring to FIG. 4, the system 400 may comprise a host 401 and a NIC 403. The host 401 may comprise a processor (CPU) 405 and a host memory 407. The host memory 407 may be the same host memory 301 as illustrated on FIG. 3, so that the host memory 407 is adapted to handle pre-pending of layer 2 (L2) frame headers. The host memory 407 may be communicatively coupled to the NIC 403 via an interface bus 409. The NIC 403 may receive packet data via the incoming data flow 411. In another embodiment of the present invention, the NIC 403 may be a part of the host 401.

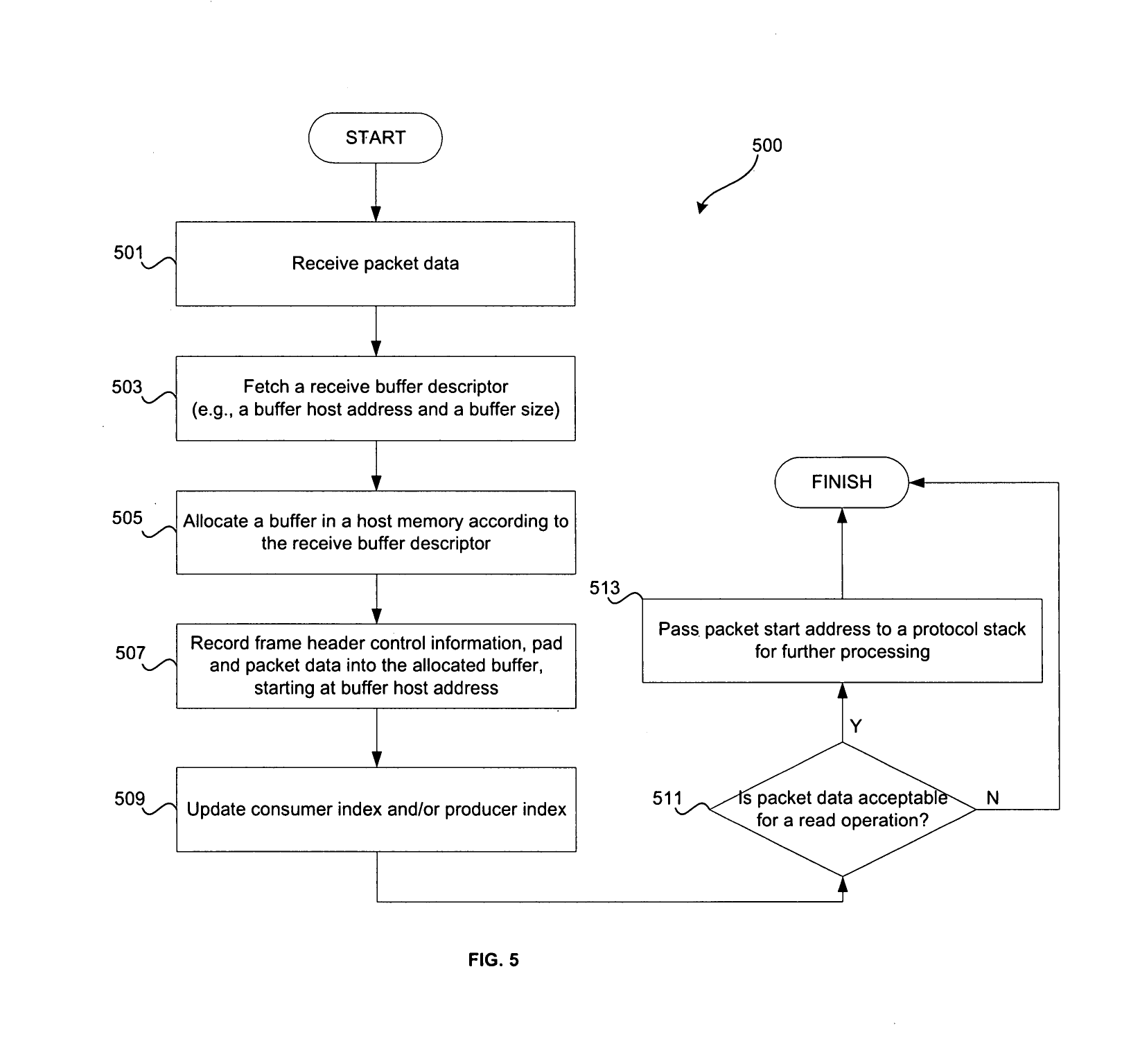

FIG. 5 is a flow diagram illustrating a method 500 for processing packetized network information that may be used in connection with pre-pending layer 2 (L2) frame descriptors, in accordance with an embodiment of the present invention. At 501, packet data may be received by a NIC, for example. The NIC may then fetch, at 503, a receive buffer descriptor from a receive BDQ. The receive buffer descriptor may comprise a host buffer address and a buffer size, for example. The NIC may then allocate, at 505, a buffer located in a host memory according to the receive buffer descriptor information. Starting from the host buffer address, the NIC may launch a single DMA write operation at 507, and may record frame header control information and pad and packet data into the allocated buffer. The frame header control information may comprise, for example, packet length, packet status, computed checksums and/or other control data associated with the received packet data. At 509, the NIC may update a consumer index and/or a producer index of the receive BDQ in order to notify a host driver of the arrival of a new packet. At 511, it may be determined whether the received packet is acceptable for a read operation, for example. If the packet is accepted, then at 513 the host driver may pass the packet start address, skipping the frame header and padding, upward to a protocol stack for further processing.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for arranging and processing packetized network information, the method comprising:
allocating a single receive buffer in a host memory-for storing packet data and control data associated with a packet; and
generating a single DMA operation for transferring the packet data and the control data into the single allocated receive buffer.

2. The method of claim 1, further comprising arranging a plurality of the single receive buffers so that they are located contiguously in the host memory.

3. The method of claim 1, further comprising writing the packet data and the control data for the packet in the single receive buffer via the single DMA operation.

4. The method of claim 1, further comprising inserting at least one pad byte in the single receive buffer for byte alignment.

5. The method of claim 4, wherein the at least one pad separates the control data from the packet data in the single receive buffer.

6. The method of claim 1, wherein the control data comprises at least one of packet length data, status data, and checksum data.

7. The method of claim 1, further comprising allocating at least one buffer descriptor for storing identifying information associated with the single receive buffer.

8. The method of claim 7, wherein the identifying information comprises at least one of host memory address and buffer size information.

9. The method of claim 7, further comprising allocating a consumer index in the host memory, the consumer index for updating notification information associated with the packet.

10. The method of claim 9, further comprising communicating the notification information to a host driver, where the host driver interfaces with the host memory.

11. The method of claim 10, further comprising determining by the host driver, upon receipt of the notification information, whether the packet is acceptable for a read operation.

12. A machine-readable storage having stored thereon, a computer program having at least one code section for arranging and processing packetized network information, the at least one code section being executable by a machine for causing the machine to perform steps comprising:
allocating a single receive buffer in a host memory for storing packet data and control data associated with a packet; and
generating a single DMA operation for transferring the packet data and the control data into the single allocated receive buffer.

13. The machine-readable storage according to claim 12, further comprising code for arranging a plurality of the single receive buffers so that they are located contiguously in the host memory.

14. The machine-readable storage according to claim 12, further comprising code for writing the packet data and the control data for the packet in the single receive buffer via the single DMA operation.

15. The machine-readable storage according to claim 12, further comprising code for inserting at least one pad byte in the single receive buffer for byte alignment.

16. The machine-readable storage according to claim 15, wherein the at least one pad separates the control data from the packet data in the single receive buffer.

17. The machine-readable storage according to claim 12, wherein the control data comprises at least one of packet length data, status data, and checksum data.

18. The machine-readable storage according to claim 12, further comprising code for allocating at least one buffer descriptor for storing identifying information associated with the single receive buffer.

19. The machine-readable storage according to claim 18, wherein the identifying information comprises at least one of host memory address and buffer size information.

20. The machine-readable storage according to claim 18, further comprising code for allocating a consumer index in the host memory, the consumer index for updating notification information associated with the packet.

21. The machine-readable storage according to claim 20, further comprising code for communicating the notification information to a host driver, where the host driver interfaces with the host memory.

22. The machine-readable storage according to claim 21, further comprising code for determining by the host driver, upon receipt of the notification information, whether the packet is acceptable for a read operation.

23. A system for arranging and processing packetized network information, the system comprising:
a host memory;
a single receive buffer allocated in the host memory for storing packet data and control data associated with a packet; and
a single DMA operation that transfers the packet data and the control data into the single allocated receive buffer.

24. The system of claim 23, wherein a plurality of the single receive buffers are arranged so that they are located contiguously in the host memory.

25. The system of claim 23, wherein the packet data and the control data for the packet are written in the allocated single receive buffer via the single DMA operation.

26. The system of claim 23, wherein the single receive buffer comprises at least one pad byte.

27. The system of claim 26, wherein the at least one pad byte separates the control data from the packet data in the single receive buffer.

28. The system of claim 23, wherein the control data comprises at least one of packet length data, status data, and checksum data.

29. The system of claim 23, further comprising at least one buffer descriptor allocated for storing identifying information associated with the single receive buffer.

30. The system of claim 29, wherein the identifying information comprises at least one of host memory address and buffer size information.

31. The system of claim 29, further comprising a consumer index allocated in the host memory, the consumer index for updating notification information associated with the packet.

32. The system of claim 31, further comprising at least one notification that is communicated to a host driver, the host driver interfaced to the host memory.

33. The system of claim 32, wherein the host driver determines, upon receipt of the notification information, whether the packet is acceptable for a read operation.
